(19) United States
(12) Patent Application Publication
(10) Pub. No.: US 2011/0315703 A1
(43) Pub. Date: Dec. 29, 2011

(54) COMPOSITE COVERS FOR CONTAINERS

(76) Inventors: Yukihiro Urushidani, St. Louis, MO (US); Stephen Ray Holten, St. Louis, MO (US)

(21) Appl. No.: 13/138,524

(22) PCT Filed: Mar. 10, 2010
(86) PCT No.: PCT/US10/00722

§ 371 Date: Aug. 30, 2011

Related U.S. Application Data
(60) Provisional application No. 61/210,067, filed on Mar. 13, 2009.

(51) Int. Cl. B65D 41/18; B23P 11/00

(52) U.S. Cl. 220/805; 29/428

(57) ABSTRACT

The invention provides composite covers and reclosable containers using the covers. In a general embodiment, the composite cover includes a flexible lid and an overcap rim fixedly attached to the flexible lid. The flexible lid includes a flexible layer, a metallic layer, and a sealant layer. A tab can be attached to at least one of the flexible layer and the metallic layer to provide a method for opening the container.

### CROSS REFERENCE TO RELATED APPLICATIONS

This application is a national stage application under 35 U.S.C. §371 of PCT/US2010/000722 filed Mar. 10, 2010, which claims priority to U.S. Provisional Application Ser. No. 61/210,067 filed Mar. 13, 2009, the disclosures of which are incorporated herein by this reference.

### BACKGROUND OF THE INVENTION

1. Field of the Invention

The invention relates generally to containers and container covers and particularly to composite covers for containers and reclosable containers using such covers.

2. Description of Related Art

Current thermo-formed plastic containers have a membrane material attached to the opening of a container to protect the product inside the container from contamination or excess moisture from the atmosphere. With the existing membrane and overcap, the user has to remove the overcap first, put aside the overcap, and then remove the membrane to reach the product inside the container. If a consumer wants to re-use the product in the container after initially opening the container, the separate overcap is placed over the container during storage. However, the overcap without the membrane may insufficiently seal the product within the container, which may cause contamination of the product during storage.

Covers for containers are known in the art. For example, US2006266751A1 discloses an overcap for selectively covering a container of a microwaveable packaged good article. The overcap includes a panel, a neck extending from the panel, and a skirt radially spaced from the neck. The skirt defines at least two areas of reduced thickness spaced from one another, which are configured to allow the skirt to flex when the overcap is removed from the container. US2002190067A1 discloses overcaps for containers useful for protecting lid portions of container during shipment, storage, and heating. The overcaps are readily releasable from the containers without undue stress. U.S. Pat. No. 6,478,218 and U.S. Pat. No. 6,829,874 disclose a tubular container for vacuum packaging products that includes an overcap secured to at least one of the opposed ends of a tubular container that defines a bias member for biasing a membrane-type flexible lid inwardly towards products contained within the tubular container before a vacuum is applied. US20060102583A1 discloses a unitary cap seal for closure installed on drum-shaped container, has annular sidewall, annular rim, circular upper panel and seal lip. US20080314916A1 discloses an overcap for a container used for packaging food products. The overcap has a wall with end portion that extends downwards in a direction away from the top surface, so as to engage the exterior facing the top surface of rim. US20070262077A1 discloses an interference-fit cap for containers that has a circumferential ring with outside surface diametrically dimensioned to produce interference-fit with the container inner wall after the membrane is removed. U.S. Pat. No. 7,394,383 discloses an overcap for closure of container that has a decorated film fused into top surface of button-like member. These references do not, however, disclose a composite cover that uses less material and ensures that the container can be resealed. There is, therefore, a need for new covers for containers and new containers using the covers that are easily reclosable and that minimize contamination when used.

### SUMMARY OF THE INVENTION

The invention provides composite covers and reclosable containers using such covers. The composite cover includes a flexible lid and an overcap rim fixedly (e.g., permanently/unable to be removed) attached to the flexible lid. The flexible lid includes a flexible layer, a metallic layer, and a sealant layer. A tab can be attached to at least one of the flexible layer and the metallic layer. The tab provides a method for easily opening the container.

In an embodiment, the composite cover includes a first adhesive attaching the flexible layer to the metallic layer. The composite cover can also include a second adhesive attaching the sealant layer to the metallic layer. The second adhesive forms a weaker adhesive bond than the first adhesive.

In an embodiment, the flexible layer includes a material such as polyester, polypropylene, paper, or a combination thereof. The metallic layer can include a material such as aluminum foil, tin foil, or a combination thereof. The sealant layer can include a material such as polypropylene, polystyrene, polyethylene, polyester, polylactic acid, or a combination thereof.

In an embodiment, the overcap rim includes a material such as polypropylene, polystyrene, polyethylene, polyester, polylactic acid, or a combination thereof.

The overcap rim can further include a tab. The tab can have ridges, groves, bumps, lines, or other similar features that permit the tab to be gripped more easily when the tab is pulled. The tab can also have one or more openings, typically in the form of holes, in the tab to facilitate opening or storing (such as by hanging) the covers or containers comprising the covers.

In one embodiment, the overcap rim contains a feature that permits containers using the lids to be stacked. In one embodiment, the overcap rim contains a recessed portion in the top panel of the overcap that matches up and/or interlocks with the geometry of the bottom panel on the base container or tray. This takes the form of a stepped shoulder or platform on the bottom tray panel that fits into a recessed area on the top center panel of the overcap. Other such stacking configurations are known to skilled artisans.

In another embodiment, the invention provides a reclosable container including a flexible lid comprising a flexible layer, a metallic layer, and a sealant layer. An overcap rim is permanently attached to the composite cover. The flexible lid is removably attached to a container. The container can include a material such as metal, polypropylene, polystyrene, polyethylene, polyester, polylactic acid, or a combination thereof.

In an alternative embodiment, the invention provides a method for making a reclosable container. The method comprises providing a flexible lid comprising a flexible layer, a metallic layer, and a sealant layer, permanently attaching an overcap rim to the flexible lid to form a composite cover, and sealing the composite cover to an opening of a container, preferably a filled container.

An advantage of the invention is to provide an improved reclosable container. Another advantage of the invention is to provide a container having an easily resealable lid. Yet another advantage of the invention is to provide a container having reduced manufacturing costs. Still another advantage of the invention is to provide a container having reduced manufacturing times.

Additional features and advantages are described herein, and will be apparent from the following Detailed Description of the Invention and the Figures.

### BRIEF DESCRIPTION OF THE FIGURES

FIG. 1 illustrates an exploded perspective view of the flexible lid, overcap rim and container in an embodiment of the invention.

FIG. 2 illustrates a perspective view of the flexible lid, overcap rim and container attached together in an embodiment of the invention.

FIG. 3 illustrates a cross-section view of the flexible lid of FIG. 1.

### DETAILED DESCRIPTION OF THE INVENTION

The invention provides composite covers and reclosable containers using such composite covers. The composite covers in embodiments of the invention eliminate a step for a consumer to reach a product stored in a reclosable container. Once the consumer removes the composite cover from the container, the consumer can reach the product directly. The composite cover can be re-applied to the container to reclose the container and store the product for a subsequent usage. In addition, manufacturing processes for reclosable containers are simplified.

The invention has several advantages over conventional covers. The present cover is basically a combined lid and over cap that eliminates the need for a down stream capping system when processing containers. The typical line setup requires a capping and cap feeding system for use after retorting. This additional equipment requires operators, incurs on-going maintenance cost, requires equipment depreciation, uses valuable floor space, and causes a combined efficiency disadvantage. The present invention saves energy by reducing equipment operations. Similarly, the present invention eliminates a significant portion of the material used to produce covers when compared to previous covers. Such covers typically have a solid plastic lid with a complete covering of foil. The present invention only uses a rim of plastic, thus eliminating the majority of the material required to make a lid. This means that there is a source or waste reduction benefit because the combined lid and over cap will use less material than a combined overcap and primary seal closure. In addition, there will be less material for disposal.

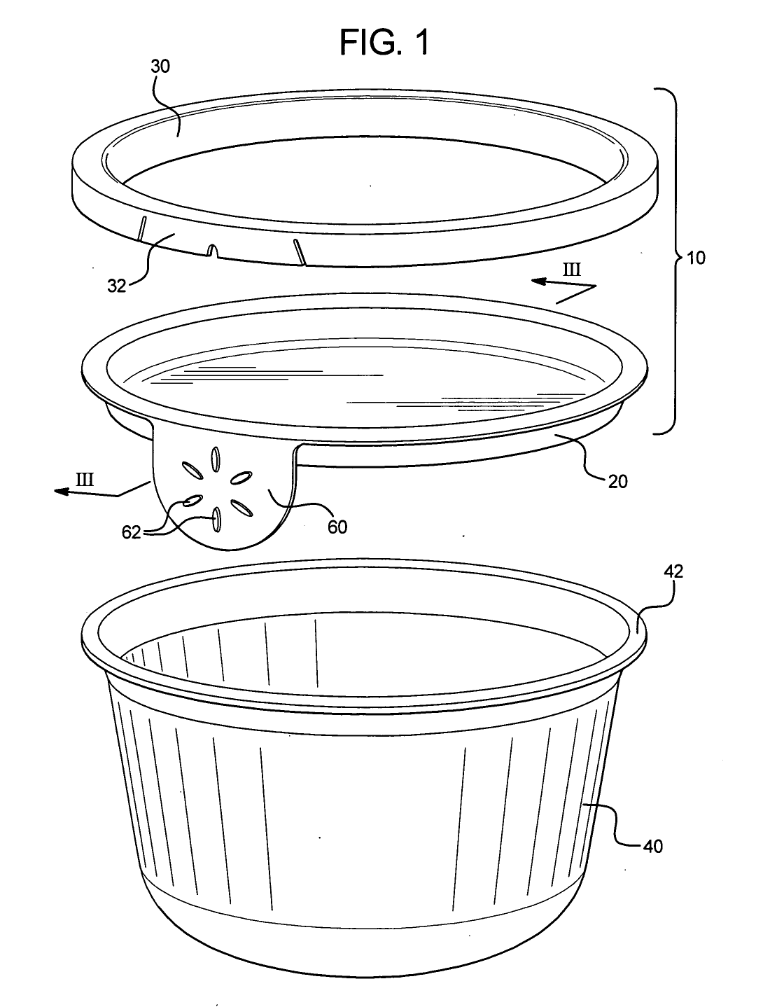

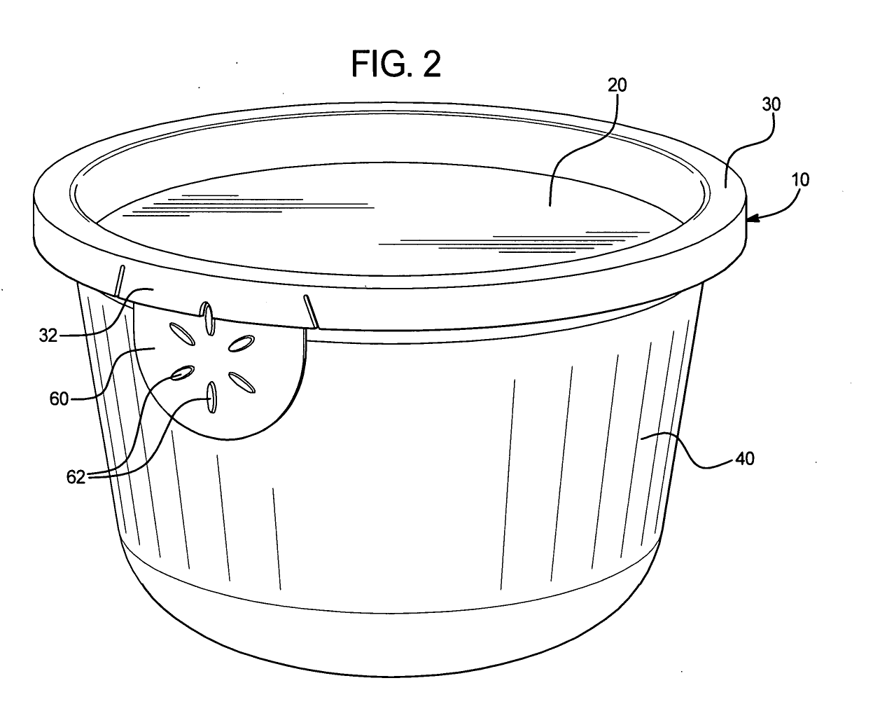

In a general embodiment illustrated in FIGS. 1-2, the invention provides a composite cover 10 including a flexible lid 20 and an overcap rim 30 fixedly attached to flexible lid 20. Composite cover 10 is removably attached to a container 40. Composite cover 10 can be any suitable shape (e.g., square, circular, polygonal) configured to be attachable to the top of container 40. Although FIG. 1 shows overcap rim 30 separated from flexible lid 20, in actuality overcap rim 30 is permanently attached to flexible lid 20 and does not separate from flexible lid 20 when composite cover 10 is removed from container 40.

Composite cover 10 can provide an air tight closure of container 40 to protect the product inside of container 40. Composite cover 10 can be heat sealed to container 40 using any suitable heat generated sealing methods to provide a tight seal around container 40. Suitable heat generated sealing methods include continuous heat sealing methods with pressure, induction sealing methods, radio frequency sealing methods, laser generated sealing methods or combinations thereof. Composite cover 10 can include a peeling feature as described in more detail below.

Container 40 can be any suitable shape (e.g., bowl-shaped having round or squared edges) for storing a product. The base or bottom of container 40 can be, for example, squared, circular, and polygonal. Container 40 can be made from a material such as metal (e.g., aluminum, steel, tin, etc.), polypropylene, polystyrene, polyethylene, polyester, polylactic acid, or a combination thereof.

Overcap rim 30 is constructed and arranged to be removably attached to a flange or rim 42 of container 40. The shape of overcap rim 30 can be designed to approximate the outer shape of rim 42 so that overcap rim 30 can form a snap-fit over rim 42 of container 40. Overcap rim 30 can be made from a moldable material such as polypropylene, polystyrene, polyethylene, polyester, polylactic acid, or a combination thereof Overcap rim 30 can be made with injection mold technology.

Overcap rim 30 can be hollow in the center to form an outer ring around flexible lid 20 so that the center of flexible lid 20 is observed. Overcap rim 30 can be directly molded onto flexible lid 20 to form a single composite cover 10. Composite cover 10 can be retorted if all the materials are made with a retortable grade resin. Because of the single composite cover 10 for container 40, faster manufacturing speeds are be attainable. In addition, the design of overcap rim 30 includes stackable features to so that similar reclosable containers can be stacked upon each other. In another embodiment, overcap rim 30 does not have a hollow center.

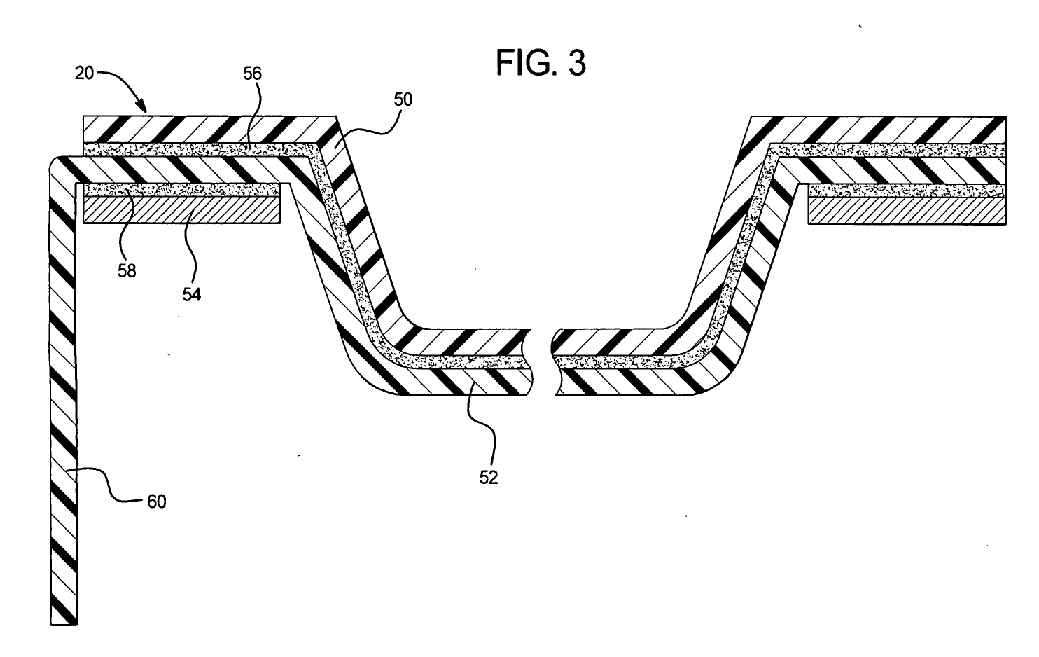

Flexible lid 20 can be made from a combination of thermoformed rigid plastics or flexible plastics or metals like aluminum foil or laminated plastic films. As illustrated in an embodiment in FIG. 3, flexible lid 20 includes a flexible layer 50, a metallic layer 52 and a sealant layer 54. Flexible layer 50 can be made from a material such as polyester, polypropylene, paper, or a combination thereof. Metallic layer 52 can be made from a material such as aluminum foil, tin foil, or a combination thereof Sealant layer 54 can be made from a material such as polypropylene, polystyrene, polyethylene, polyester, polylactic acid, or a combination thereof. The top of flexible lid 20 can also contain a medium that can be printed upon for advertising purposes.

Flexible lid 20 can include a first adhesive 56 attaching flexible layer 50 to metallic layer 52. Flexible lid 20 can also includes a second adhesive 58 attaching sealant layer 54 to metallic layer 52. Second adhesive 58 can form a weaker adhesive bond than that of first adhesive 56. In an alternative embodiment, second adhesive 58 can form an adhesive bond have a similar strength with that of first adhesive 56.

A base material for first adhesive 56 and second adhesive 58 can be isocyanate-terminated urethane prepolymer. First adhesive 56 can be mixed with a curing agent such as toluene diisocyanate to activate as an adhesive. Second adhesive 58 can be mixed with curing agent such as xylene di-isocyanate or isophoron di-isocyanate.

Composite cover 10 can be removably attached to rim 42 of container 40. For example, sealant layer 54 of flexible lid 20 can be heat sealed to rim 42 of container 40. Composite cover 10 is designed so that second adhesive 58 forms a weaker adhesive bond than that of first adhesive 56. When composite cover 10 is removed from the top of container 40, metallic layer 52 separates from sealant layer 54 at second adhesive layer 58. As a result, sealant layer 54 remains on the rim 42 when composite cover 10 is unpeeled or removed from the container 40.

In another embodiment, sealant layer 54 of flexible lid 20 can be releasably sealed to rim 42 of container 40, for example, using an adhesive or a lower heat sealing temperature. Composite cover 10 is designed so that second adhesive 58 forms an adhesive bond having a strength similar to that of first adhesive 56 while both are stronger than the bond between sealant layer 54 and rim 42. When composite cover 10 is removed from the top of container 40, sealant layer 54 separates from rim 42. As a result, sealant layer 54 remains part of composite cover 10 when composite cover 10 is unpeeled or removed from container 40.

A tab 60 can be attached to at least one of flexible layer 50 and metallic layer 52. A consumer can pull tab 60 to initiate removing composite cover 10 from container 40. Tab 60 can be made of the same material as the layer (e.g., flexible layer 50/metallic layer 52) to which tab 60 is attached and be formed integrally with the layer. Alternatively, tab 60 can be made of a different of a different material than the layer to which tab 60 is attached. In this regard, tab 60 can be attached to the layer using a suitable attachment mechanism such as an adhesive or heat welding. As shown in FIG. 1, tab 60 can include gripping elements 62 that the consumer can grab to assist in removing composite cover 10.

In an embodiment, overcap rim 30 can include a frangible portion 32 that is breakable. The breaking of frangible portion 32 can be used to accommodate the repositioning of overcap rim 30 from a downwardly bent position (see FIG. 1) to an upwardly bending position (not shown) when tab 60 has been pulled by the consumer. In addition, the breaking of frangible portion 32 can also be used to identify that the seal between composite cover 10 and container 40 has been broken. In an alternative embodiment, overcap rim 30 can include a tab (not shown).

Generally, any suitable product can be placed in container 40. Composite cover 10 can then be sealed over container 40. Because composite cover 10 includes flexible lid 20 that seals the opening of container 40 and reclosable overcap rim 30 in one piece, the manufacturing process for the reclosable container can be simplified. For example, in a two part packaging process involves a step for sealing a membrane onto the opening of a container, preferably a filled container. A second step involves applying an overcap to the sealed container. Embodiments of the invention allow for these two steps to be combined as one operation in a production line. This allows for faster manufacturing operating speeds for producing the containers. The composite cover can also eliminate the need for a down stream, post retort capping system.

By reducing steps in the manufacturing process when making reclosable containers in embodiments of the invention, maintenance costs and depreciation can be reduced and valuable floor space can be optimized. There can also be a source/waste reduction benefit because the composite cover can use less material to make and resulting in less waste to dispose of. An energy savings can be obtained because power requirements for manufacturing steps involving a filler/sealer, capper, bulk feeder and cover conveying system can be simplified or reduced by having just a cover feeder and filler/sealer setup to make the reclosable containers in embodiments of the invention.

During actual use, a consumer can also avoid having to remove an overcap, put aside the overcap, and then remove the membrane to reach the product inside the container. Instead, in embodiments of the invention, the consumer removes the composite cover from the container in a single step. After the consumer is finished with the product, the reclosable composite cover can easily be used to reclose and sufficiently seal the product within the container to prevent contamination of the product during storage.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A cover for containers comprising:
a flexible lid comprising a flexible layer, a metallic layer, and a sealant layer; and
an overcap rim permanently attached to the flexible lid.

2. The cover of claim 1 comprising a first adhesive attaching the flexible layer to the metallic layer.

3. The cover of claim 1 comprising a second adhesive attaching the sealant layer to the metallic layer.

4. The cover of claim 1 wherein the flexible layer comprises a material selected from a group consisting of polyester, polypropylene, paper, and combinations thereof.

5. The cover of claim 1 wherein the metallic layer comprises a material selected from the group consisting of aluminum foil, tin foil and combinations thereof.

6. The cover of claim 1 wherein the sealant layer comprises a material selected from the group consisting of polypropylene, polystyrene, polyethylene, polyester, polylactic acid, and combinations thereof.

7. The cover of claim 1 wherein the overcap rim comprises a material selected from the group consisting of polypropylene, polystyrene, polyethylene, polyester, polylactic acid, and combinations thereof.

8. The cover of claim 1 further comprising a tab attached to at least one of the flexible layer and the metallic layer.

9. The cover of claim 1 wherein the overcap rim comprises a tab.

10. A reclosable container comprising:
a flexible lid comprising a flexible layer, a metallic layer, and a sealant layer;
an overcap rim permanently attached to the flexible lid; and
a container comprising a rim, wherein the flexible lid is removably attached to the rim.

11. The reclosable container of claim 10 comprising a first adhesive attaching the flexible layer to the metallic layer.

12. The reclosable container of claim 10 comprising a second adhesive attaching the sealant layer to the metallic layer, the second adhesive forming a weaker adhesive bond than the first adhesive.

13. The reclosable container of claim 10 wherein the flexible layer comprises a material selected from a group consisting of polyester, polypropylene, and combinations thereof.

14. The reclosable container of claim 10 wherein the metallic layer comprises a material selected from the group consisting of aluminum foil, tin foil and combinations thereof.

15. The reclosable container of claim 10 wherein the sealant layer comprises a material selected from the group consisting of polypropylene, polystyrene, polyethylene, polyester, polylactic acid, and combinations thereof.

16. The reclosable container of claim 10 wherein the overcap rim comprises a material selected from the group consisting of polypropylene, polystyrene, polyethylene, polyester, polylactic acid, and combinations thereof.

17. The reclosable container of claim 10 further comprising a tab attached to at least one of the flexible layer and the metallic layer.

18. The reclosable container of claim 10 wherein the overcap rim comprises a tab.

19. The reclosable container of claim 10 wherein the container comprises a material selected from the group consisting of metal, polypropylene, polystyrene, polyethylene, polyester, polylactic acid, and combinations thereof.

20. A method for making a reclosable container comprising:
providing a flexible lid comprising a flexible layer, a metallic layer, and a sealant layer;
permanently attaching an overcap rim to the flexible lid to form a composite cover; and
sealing the composite cover to an opening of a container.
